(19) United States
(12) Patent Application Publication
(10) Pub. No.: US 2023/0137989 A1
(43) Pub. Date: May 4, 2023

(54) SOIL IMPROVING AGENT

(71) Applicant: KAO CORPORATION, Tokyo (JP)

(72) Inventors: Yumi MOCHIZUKI, Wakayama-shi, Wakayama (JP); Akihiro TANOUE, Wakayama-shi, Wakayama (JP); Ryosuke YASUI, Wakayama-shi, Wakayama (JP); Ryosuke KOBE, Wakayama-shi, Wakayama (JP)

(73) Assignee: KAO CORPORATION, Tokyo (JP)

(21) Appl. No.: 17/910,446

(22) PCT Filed: Mar. 30, 2021
(86) PCT No.: PCT/JP2021/013545

§ 371 Date: Sep. 9, 2022

(30) Foreign Application Priority Data
Mar. 31, 2020 (JP) 2020-063570

(51) Int. Cl. C09K 17/32

(52) U.S. Cl. CPC C09K 17/32

(57) ABSTRACT

A soil improving agent containing (A) a lignocellulosic biomass with a lignin content of more than 60 mass % and 80 mass % or less.

### FIELD OF THE INVENTION

The present invention relates to a soil improving agent, a method for producing a soil improving agent and a method for improving soil.

### BACKGROUND OF THE INVENTION

In agricultural fields to cultivate farm products, properties of soil are an important factor from the viewpoint of productivity or the like. For example, soil formed of soil aggregates has moderate pore spaces, and is excellent in drainage and water retention capacity, as well as being soft. Aggregated soil is ideal as soil to cultivate crops because of such characteristics. Conventionally, various technologies for improving properties of soil have been proposed. Some of them use plant-based materials.

JP-A 2012-17459 discloses a method for producing a soil improving material comprising, saccharifying a lignocellulosic biomass through predetermined steps.

JP-A 2006-213900 discloses a pellet-form soil improving agent with a density of 0.8 to 3.0 g/cm³ and expanding its volume 2 to 100 times when absorbing water, wherein the agent is made of a raw material plant-based material including 50 weight % or more of bark.

JP-A 545-3171 discloses a method for producing a soil improving agent for suspensions comprising, immersing a coal such as grass peat, peat, lignite or the like with a low humification degree in an alkaline solution of about 5 to 10%, adding an acid thereto to carry out a treatment, and thereafter neutralizing.

JP-A 2017-190448 discloses a soil improvement agent comprising, as an effective component, a lignin decomposition product having an aldehyde yield by alkaline nitrobenzene oxidation of 5% by mass or more, a weight average molecular weight of 300 or more and 100,000 or less, and a contact angle with water of 150 or more.

WO-A 2019/078208 discloses a plant growth-promoting agent comprising a lignocellulosic biomass, wherein the lignocellulosic biomass has a lignin content of 40% by mass or more and 60% by mass or less and a contact angle with water of 50° or less, and a soil aggregating agent comprising the predetermined lignocellulosic biomass.

Further, various solution technologies have been developed to address the issue of reduced germination rates due to soil crusting. J. Jpn. Soc. Soil Phys., 2006, 103, 3-12. describes that soil crust formation can be prevented by adding borrowed sandy pyroclastic flow deposits to soil where soil crust formation is observed.

### SUMMARY OF THE INVENTION

For improving drainage or aeration of the soil of an agricultural field or the like, promoting soil aggregation to reduce fine soil particles is considered to be more effective. Further, it is also desirable that soil aggregates (hereinafter referred to as soil aggregates) be excellent in stability, for example, be excellent in water resistance.

On the other hand, in an agricultural field, the soil is usually plowed by a tiller or the like before farm products are cultivated. In usual operations in a tiller, excellent soil crushing performance such as the ability to easily crush hardened soil, no reaggregation of crushed soil, or the like is desirable from the viewpoint of work efficiency or plant seedling establishment or growth.

The present invention provides a soil improving agent that is capable of reducing fine soil particles by forming soil aggregates with excellent stability from soil, and is also excellent in soil crushing performance during tilling. In the present invention, soil improvement may be, for example, changing physical characteristics of soil depending on its intended use to make it conducive to such use. Specifically, it may be, for example, improving the ability to crush soil, forming soil aggregates excellent in stability such as water resistance or the like, reducing fine soil particles, or achieving more than one of these.

The present invention relates to a soil improving agent containing (A) a lignocellulosic biomass with a lignin content of more than 60 mass % and 80 mass % or less.

The present invention relates to a method for producing a soil improving agent containing (A) a lignocellulosic biomass with a lignin content of more than 60 mass- and 80 mass % or less, wherein the method includes a step of subjecting the lignocellulosic biomass to a hydrophilization treatment.

Further, the present invention relates to a method for improving soil including, mixing (A) a lignocellulosic biomass with a lignin content of more than 60 mass % and 80 mass % or less [hereinafter referred to as component (A)] with the soil.

According to the present invention, provided are a soil improving agent that is capable of reducing fine soil particles by forming soil aggregates with excellent stability from soil, and is also excellent in soil crushing performance during tilling, and a method for producing the same, and a method for improving soil using the soil improving agent. The present invention provides a soil improving agent for improving soil to make it suitable for growing plants such as farm products or the like, and a method for producing the same, and a method for improving soil using the soil improving agent. Note that excellent soil crushing performance may be advantages that are brought during crushing of soil, for example, the ability to easily crush hardened soil, no reaggregation of crushed soil, or the like.

### EMBODIMENTS OF THE INVENTION

### <Soil Improving Agent>

The soil improving agent of the present invention is a soil improving agent containing component (A), which is a lignocellulosic biomass with a lignin content of more than 60 mass % and 80 mass % or less (hereinafter sometimes also referred to as the lignocellulosic biomass of the present invention). The soil improving agent of the present invention contains the lignocellulosic biomass of the present invention as an active component for improving soil.

The lignin content of the lignocellulosic biomass of the present invention is more than 60 mass % and preferably 63 mass % or more, and 80 mass % or less, preferably 77 mass % or less, more preferably 75 mass % or less and further preferably 70 mass % or less from the viewpoints of the ability to crush soil and reducing fine particles by aggregating soil. Note that the lignin content of the lignocellulosic biomass of the present invention refers to the lignin content of a raw material for the biomass, for example, a plant biomass. For example, the lignocellulosic biomass of the present invention may be obtained by subjecting a plant biomass to a hydrophilization treatment, in which case the lignin content of the raw material plant biomass is adopted.

The lignin content of the lignocellulosic biomass of the present invention is determined by the Klason lignin method. In other words, the percentage of an acid-insoluble lignin and the percentage of an acid-soluble lignin are summed to calculate the total lignin content in accordance with the TAPPI official analysis method T222om-83.

Further, the lignocellulosic biomass of the present invention may have a contact angle with water (hereinafter sometimes also referred to as water contact angle) of, for example, 110° or less, further 100° or less, further 95° or less, further less than 70°, further 60° or less, further 55° or less and further 50° or less, and 0° or more, further 5° or more, further 10° or more and further 15° or more from the viewpoints of the ability to crush soil and reducing fine particles by aggregating soil.

The water contact angle of the lignocellulosic biomass of the present invention is measured under the following conditions.

### [Method for Measuring Water Contact Angle of Lignocellulosic Biomass]

The lignocellulosic biomass to be measured is usually obtained as a solid such as a powder or the like. 0.1 to 0.3 g of the solid is sampled and pressurized with a powder molding machine (Minilabo press MP-50, manufactured by Labonect co., ltd.) until 20 MPa is reached to form a compacted product, which is used as a sample. Note that, when particles of the lignocellulosic biomass to be measured are large in size, non-uniform in shape, or the like, they may be ground into a powder with an adjusted particle size or shape, from which a compacted product may be formed as mentioned above and used as a sample. Further, the powder of the lignocellulosic biomass may be compacted into a granule.

A sample, for example, a compacted product of the lignocellulosic biomass is placed with a flat surface thereof kept horizontal, and pure water at 20° C. is added dropwise to the flat surface with a droplet size of 5 μm and the contact angle immediately after the dropwise addition is measured. The contact angle is determined by measuring the angle of a straight line connecting the left or right end point and the apex of the droplet relative to the solid surface and doubling the angle (a half-angle method). Measurements are made three times per sample, and a value obtained as the average value thereof is adopted as the water contact angle.

A raw material for the lignocellulosic biomass of the present invention is preferably selected from plant biomass. Examples of types of the plant biomass include herbaceous biomass and woody biomass. Among these, herbaceous biomass is preferable.

Herbaceous biomass means plant raw materials growing in grassland other than trees, or non-woody parts of plants. Specific examples thereof include plant raw materials of the Poaceae, Malvaceae and Fabaceae families, and non-woody raw materials of plants of the Arecaceae family.

Examples of the plant raw materials of the Poaceae family include, for example, bagasse such as sugarcane bagasse, sorghum bagasse or the like, switchgrass, elephant grass, corn stover, corncobs, rice straw, wheat straw, barley, Miscanthus sinensis, sod, Johnson grass, Saccharum and Napier grass. Examples of the plant raw materials of the Malvaceae family include, for example, kenaf and cotton. Examples of the plant raw materials of the Fabaceae family include, for example, alfalfa. Examples of the non-woody raw materials of plants of the Arecaceae family include, for example, palm kernel shells and palm empty fruit bunches.

A raw material for the lignocellulosic biomass of the present invention can also be selected from plant seed husks, which are a type of plant biomass, such as peach seed husks, prune seed husks, Japanese apricot seed husks, plum seed husks, peanut seed husks, walnut seed husks or the like. Palm kernel shells mentioned above are also a plant seed husk.

Examples of the woody biomass include various types of wood such as wood chips obtained from conifers such as Larix kaempferi, Taxodium distichum or the like or broad-leaved trees such as Elaeis guineensis, Chamaecyparis obtuse or the like, and others, wood pulp produced from these woods, or the like.

Only one or a combination of two or more of the above types of plant biomass may be used.

Among these types of plant biomass, lignocellulosic biomass is preferably used as a raw material. Lignocellulosic biomass is composed mainly of cellulose, hemicellulose and lignin. Among lignocellulosic biomass, a lignocellulosic biomass with a lignin content of more than 60 mass % and 80 mass % or less can be used as-is as the lignocellulosic biomass of the present invention.

The lignocellulosic biomass of the present invention is preferably a biomass derived from a plant of the Arecaceae family. Further, the lignocellulosic biomass of the present invention is preferably a lignocellulosic biomass selected from palm kernel shells and coconut coir dust.

The lignocellulosic biomass of the present invention may be obtained by subjecting any of the above types of plant biomass to a hydrophilization treatment such as a hot water treatment, an alkali treatment, an acid treatment or the like. The lignocellulosic biomass of the present invention is preferably a hydrophilized lignocellulosic biomass subjected to such a treatment. It is considered that such a treatment produces a lignocellulosic biomass with an increased surface area and improved affinity for soil, resulting in an environment desirable for the growth of plants, for example, with soil aggregation, improved soil crushing performance or the like. Therefore, a hydrophilized lignocellulosic biomass is more preferable for obtaining the effects of the present invention.

The lignocellulosic biomass of the present invention is preferably in solid form. It may be in any solid form that is easily formed from a natural biomass, such as a powder, a pellet or the like.

The lignocellulosic biomass of the present invention has an average particle size of preferably 1,000 μm or less, more preferably 500 μm or less, further preferably 300 μm or less, furthermore preferably 150 μm or less and furthermore preferably 100 μm or less, and preferably 0.1 μm or more, more preferably 1.0 μm or more and further preferably 10 μm or more. Note that the average particle size of the lignocellulosic biomass of the present invention is measured with the laser diffraction/scattering particle size distribution analyzer “LA-950” (manufactured by HORIBA, Ltd.).

The soil improving agent of the present invention may have a water contact angle of, for example, 110° or less, further 100° or less, further 950 or less, further less than 70°, further 600 or less, further 55° or less and further 50° or less, and 0° or more, further 5° or more, further 10° or more and further 15° or more. The water contact angle of the soil improving agent is measured in the same manner as in the method for measuring the water contact angle of the lignocellulosic biomass except that the lignocellulosic biomass is replaced with the soil improving agent.

The soil improving agent of the present invention is preferably in solid form. The soil improving agent may be in any form that is easily formed from components including a natural biomass, such as a powder, a pellet or the like. Further, the soil improving agent can be applied as a powder agent or a granule agent when given to actual farmland. Particularly, to prevent the soil improving agent from flying in the wind, it is preferably molded as a granule agent and applied to soil. When the soil is tilled, the granule agent of the soil improving agent applied to the soil collapses into particles with an average particle size of preferably 1,000 μm or less in the soil to exhibit the aggregation effect and the effect of improving soil crushing performance.

The soil improving agent of the present invention has an average particle size of preferably 1,000 μm or less, more preferably 500 μm or less, further preferably 300 μm or less, furthermore preferably 150 μm or less and furthermore preferably 100 μm or less, and preferably 0.1 μm or more, more preferably 1.0 μm or more and further preferably 10 μm or more. Note that the average particle size of the soil improving agent of the present invention is measured with the laser diffraction/scattering particle size distribution analyzer “LA-950” (manufactured by HORIBA, Ltd.).

The soil improving agent of the present invention contains the lignocellulosic biomass of the present invention in an amount of preferably 10 mass % or more and more preferably 20 mass % or more, and preferably 100 mass % or less. The soil improving agent of the present invention may be composed of the lignocellulosic biomass of the present invention. Further, the soil improving agent of the present invention can contain components other than the lignocellulosic biomass of the present invention.

The soil improving agent of the present invention can contain (B) a cellulose derivative [hereinafter referred to as component (B)]. Component (B) is a preferable component from the viewpoint of improving the water resistance of soil aggregates.

Examples of component (B) include, for example, one or more selected from the following (B1) to (B6):

(B1) carboxyalkyl celluloses or salts thereof;

(B2) carboxyalkyl alkyl celluloses or salts thereof;

(B3) alkyl celluloses;

(B4) hydroxyalkyl celluloses;

(B5) alkyl hydroxyalkyl celluloses; and

(B6) cationized celluloses.

(B1) is carboxyalkyl celluloses or salts thereof. Examples of (B1) include, for example, carboxyalkyl celluloses having an alkyl group with 1 or more and 4 or less carbons to which a carboxy group is bonded, or salts thereof. Specific examples of (B1) include carboxymethyl cellulose or salts thereof, carboxyethyl cellulose or salts thereof, or the like. Here, the salts of (B1) are sodium, potassium, calcium, ammonium salts or the like.

(B2) is carboxyalkyl alkyl celluloses or salts thereof. Examples of (B2) include, for example, carboxyalkyl alkyl celluloses having an alkyl group with 1 or more and 4 or less carbons to which a carboxy group is bonded and an alkyl group with 1 or more and 4 or less carbons, or salts thereof. Specific examples of (B2) include carboxymethyl methyl cellulose or salts thereof, carboxymethyl ethyl cellulose or salts thereof, or the like. Here, the salts of (B2) are sodium, potassium, calcium, ammonium salts or the like.

(B3) is alkyl celluloses. Examples of (B3) include, for example, alkyl celluloses having an alkyl group with 1 or more and 4 or less carbons. Specific examples of (B3) include methyl cellulose, ethyl cellulose or the like.

(B4) is hydroxyalkyl celluloses. Examples of (B4) include, for example, hydroxyalkyl celluloses having a hydroxyalkyl group with 2 or more and 4 or less carbons. Specific examples of (B4) include hydroxyethyl cellulose, hydroxypropyl cellulose or the like.

(B5) is alkyl hydroxyalkyl celluloses. Examples of (B5) include, for example, alkyl hydroxyalkyl celluloses having an alkyl group with 1 or more and 4 or less carbons and a hydroxyalkyl group with 2 or more and 4 or less carbons. Specific examples of (B5) include hydroxyethyl methyl cellulose, hydroxyethyl ethyl cellulose, hydroxypropyl methyl cellulose, hydroxypropyl ethyl cellulose or the like.

(B6) is cationized celluloses. Examples of (B6) include, for example, cationized hydroxyalkyl celluloses. Examples of the cationized hydroxyalkyl celluloses include, for example, cationized hydroxyalkyl celluloses having a cationic group and an alkyleneoxy group which has 1 or more and 4 or less carbons and may have a substituent such as a hydroxy group or the like. The cationic group is preferably a quaternary ammonium group. Specific examples of (B6) include cationized hydroxymethyl celluloses, cationized hydroxyethyl celluloses, cationized hydroxypropyl celluloses, cationized hydroxybutyl celluloses or the like. More specifically, examples of the cationized hydroxyethyl celluloses include hydroxyethyl cellulose hydroxypropyl trimethyl ammonium chloride ether.

Component (B) is preferably a cellulose ether. (B1) to (B6) are cellulose ethers. Preferable is a cellulose ether having one or more substituents selected from a carboxymethyl group, a carboxyethyl group, an alkyl group with 1 or more and 4 or less carbons, a hydroxyalkyl group with 2 or more and 4 or less carbons and a cationized hydroxyalkyl group, and further, a carboxymethyl group. The carboxy group may be a salt.

Component (B) may be a water-soluble cellulose. Here, being water-soluble in the context of component (B) means that 1.0 g or more is dissolved with 100 g of water at 25° C.

Component (B) is preferably any of (B1) carboxyalkyl celluloses or salts thereof, and more preferably carboxymethyl cellulose or a salt thereof.

When component (B) is a cellulose ether such as carboxymethyl cellulose or the like, component (B) has an average degree of substitution of preferably 0.5 or more and 1.5 or less.

Further, the 1 mass % aqueous solution of component (B) preferably has a viscosity of 5 mPa·s or more, and 20,000 mPa·s or less and further 15,000 mPa·s or less at 20° C. This viscosity is obtained by measuring the 1 mass % aqueous solution at 20° C. with a B-type viscometer.

When the soil improving agent of the present invention contains component (B), the agent contains component (B) in an amount of preferably 0.01 parts by mass or more, more preferably 0.1 parts by mass or more and further preferably 1 part by mass or more, and preferably 10,000 parts by mass or less, more preferably 1,000 parts by mass or less and further preferably 100 parts by mass or less relative to 100 parts by mass of component (A) from the viewpoint of improving the water resistance of soil aggregates.

The soil improving agent of the present invention can contain (C) a hydroxy acid or a salt thereof [hereinafter referred to as component (C)]. Component (C) is a preferable component from the viewpoints of soil aggregation and/or improvement of the water resistance of soil aggregates.

Examples of component (C) include malic acid, citric acid, isocitric acid, isopropyl citrate, hydroxymalonic acid, tartaric acid, 3-hydroxy-3-methylglutaric acid, mucic acid, gluconic acid, gallic acid, mevalonic acid, pantoic acid, orsellinic acid, gentisic acid, quinic acid and salts thereof. Examples of the salts include sodium salts, potassium salts, calcium salts, ammonium salts or the like. Component (C) is preferably a polycarboxylic acid having a hydroxy group or a salt thereof, more preferably citric acid, malic acid or a salt thereof, and further preferably citric acid or a salt thereof. The polycarboxylic acid having a hydroxy group may have 1 or more and 4 or less hydroxy groups. The polycarboxylic acid having a hydroxy group may have, for example, 3 or more and 10 or less carbons. Further, component (C), for example, a polycarboxylic acid having a hydroxy group or a salt thereof may be a hydrate.

When the soil improving agent of the present invention contains component (C), the agent contains component (C) in an amount of preferably 0.01 parts by mass or more, more preferably 0.1 parts by mass or more, further preferably 1 part by mass or more and further preferably 5 parts by mass or more, and preferably 10,000 parts by mass or less, more preferably 1,000 parts by mass or less and further preferably 100 parts by mass or less relative to 100 parts by mass of component (A) from the viewpoints of soil aggregation and/or improvement of the water resistance of soil aggregates. When the soil improving agent of the present invention includes components (B) and (C), the agent preferably includes component (C) in an amount falling within the above range relative to 100 parts by mass of component (A) from the same viewpoints.

When component (C) is used, it is preferable from the viewpoint of improving the water resistance of soil aggregates that components (B) and (C) be used together with component (A).

The soil improving agent of the present invention can be applied to various types of soil, and is suitable for agricultural soil, especially the soil of an agricultural field. In other words, the soil improving agent of the present invention is preferably for use in agriculture, and further for use in agricultural fields.

The soil improving agent of the present invention can contain as other optional components, for example,

(1) fertilizer components,
(2) mineral powders or clay components such as zeolite, vermiculite, bentonite, soft silica (silicate clay), perlite, peat moss, bark compost or the like, or other soil improving components,
(3) polymeric substances such as polyethyleneimine, polyvinyl alcohol, polyacrylic acid or the like,
(4) signaling molecules such as chitooligosaccharides, chitinous compounds, or flavonoids such as, for example, isoflavones, rutin or the like,
(5) fungus such as arbuscular mycorrhizal fungus or the like,
(6) bacteria such as bacteria of the genus Bacillus, bacteria of the genus Pseudomonas, bacteria of the genus Azospirillum, bacteria of the genus Paenibacillus, bacteria of the genus Burkholderia, bacteria of the genus Serratia, bacteria of the genus Enterobacter, bacteria of the genus Brevibacterium, bacteria of the genus Curtobacterium, symbiotic bacteria in root nodules of legumes or the like,
(7) soyasaponins, and others.

Among the above components, examples of the arbuscular mycorrhizal fungus in (5) can include fungus belonging to the genus Gigaspora or the genus Glomus. Among these, examples of the fungus of the genus Glomus can include Glomus intraradices.

Among the above components, examples of the bacteria of the genus Bacillus in (6) can include Bacillus amyloliquefaciens, Bacillus licheniformis, Bacillus subtilis or Bacillus thuringiensis. Examples of the bacteria of the genus Pseudomonas can include Pseudomonas putida or Pseudomonas fluorescens. Examples of the bacteria of the genus Azospirillum can include Azospirillum brasilense, Azospirillum lipoferum, Azospirillum halopraeferens or Azospirillum amazonense. Examples of the bacteria of the genus Paenibacillus can include Paenibacillus polymyxa or Paenibacillus macerans. Examples of the bacteria of the genus Burkholderia can include Burkholderia gladioli. Examples of the bacteria of the genus Serratia can include Serratia marcescens. Examples of the bacteria of the genus Enterobacter can include Enterobacter cloacae. Examples of the bacteria of the genus Brevibacterium can include Brevibacterium iodinum or Brevibacterium brevis. Examples of the bacteria of the genus Curtobacterium can include Curtobacterium flaccumfaciens. Examples of the symbiotic bacteria in root nodules of legumes can include bacteria belonging to the genus Rhizobium, the genus Bradyrhizobium or the genus Azorhizobium. Examples of the bacteria of the genus Bradyrhizobium can include Bradyrhizobium diazoefficiens, Bradyrhizobium japonicum, Bradyrhizobium elkanii or Ensifer fredii.

Among the above components, examples of the soyasaponins in (7) include those described in paragraph [0028] of WO-A 2018-159393.

The soil improving agent of the present invention can contain the fertilizer components of (1) in an amount of 1 mass % or more and 50 mass % or less.

The soil improving agent of the present invention can contain the mineral powders or clay components or other soil improving components of (2) or the polymeric substances of (3) in an amount of 1 mass % or more and 50 mass % or less each.

The soil improving agent of the present invention can contain the signaling molecules of (4) in an amount of 2.5×10⁻¹³ mass or more and 2.5×10⁻¹¹ mass % or less. The soil improving agent of the present invention can contain the fungus of (5) and/or the bacteria of (6) in an amount of 10² cfu (colony-forming unit) or more and 10¹ cfu or less per gram of the lignocellulosic biomass of the present invention each. Here, the colony-forming unit means the number of spores in the case of fungus.

The soil improving agent of the present invention can contain the soyasaponins of (7) such that they are used, for example, in an amount falling within the ranges described in paragraph [0040] of WO-A 2018-159393.

It is expected that, by adding the soil improving agent of the present invention to soil, useful microorganisms existing in the soil, for example, plant growth-promoting bacteria such as arbuscular mycorrhizal fungus, bacteria of the genus Bacillus, bacteria of the genus Pseudomonas, bacteria of the genus Azospirillum, bacteria of the genus Paenibacillus, bacteria of the genus Burkholderia, bacteria of the genus Serratia, bacteria of the genus Enterobacter, bacteria of the genus Brevibacterium, bacteria of the genus Curtobacterium or the like, and symbiotic bacteria in root nodules of legumes can be more active and grow on plants in enhanced amounts. Similarly, it is also expected that plant growth-promoting bacteria such as arbuscular mycorrhizal fungus, bacteria of the genus Bacillus, bacteria of the genus Pseudomonas, bacteria of the genus Azospirillum, bacteria of the genus Paenibacillus, bacteria of the genus Burkholderia, bacteria of the genus Serratia, bacteria of the genus Enterobacter, bacteria of the genus Brevibacterium, bacteria of the genus Curtobacterium or the like, or symbiotic bacteria in root nodules of legumes contained in the soil improving agent of the present invention can be more active and grow on plants in enhanced amounts.

The soil improving agent of the present invention can contain a surfactant from the viewpoint of increasing the amount of the lignocellulosic biomass of the present invention adhering to and percolating through a part to be acted upon. Examples of the surfactant include one or more surfactants selected from nonionic surfactants, anionic surfactants, cationic surfactants and amphoteric surfactants. The surfactant is preferably a nonionic surfactant.

When the soil improving agent of the present invention contains a surfactant, it contains the surfactant in an amount of preferably 0.01 parts by mass or more, more preferably 0.1 parts by mass or more and further preferably 1 part by mass or more, and preferably 100 parts by mass or less, more preferably 80 parts by mass or less and further preferably 50 parts by mass or less relative to 100 parts by mass of the lignocellulosic biomass of the present invention.

The soil improving agent of the present invention can contain a water-soluble polymer (excluding component (B)) from the viewpoint of soil aggregation. Here, “water-soluble” in the context of the water-soluble polymer means that 1 g or more is dissolved with 100 g of water at 20° C. Any of natural, semi-synthetic and synthetic polymers can be used as the water-soluble polymer, and a polysaccharide-based water-soluble polymer is especially preferable. Specific examples of the polysaccharide-based water-soluble polymer include guar gum, xanthan gum, starch, tara gum, locust bean gum, carrageenan and derivatives thereof. When the soil improving agent of the present invention contains a water-soluble polymer, it contains the water-soluble polymer in an amount of preferably 1 part by mass or more, more preferably 10 parts by mass or more and further preferably 50 parts by mass or more, and preferably 1,900 parts by mass or less, more preferably 600 parts by mass or less and further preferably 300 parts by mass or less relative to 100 parts by mass of the lignocellulosic biomass of the present invention.

In addition to the above, the soil improving agent of the present invention can contain, for example, fertilizer components or the like. Specifically, fertilizer components available in the product name of HYPONICA (Kyowa Co., Ltd.), HYPONeX or the like can be contained in an amount of 1 part by mass or more and 1,900 parts by mass or less relative to 100 parts by mass of the lignocellulosic biomass of the present invention.

The soil improving agent of the present invention usually takes the form of a particle including the lignocellulosic biomass of the present invention, but can also take the form of a molded product of the lignocellulosic biomass of the present invention, a composite material of the lignocellulosic biomass of the present invention with other materials, or the like.

### <Method for Producing Soil Improving Agent>

The present invention provides a method for producing the soil improving agent of the present invention including, a step of subjecting the lignocellulosic biomass to a hydrophilization treatment. Preferable aspects for a raw material plant biomass used in the method for producing a soil improving agent of the present invention are the same as those in the soil improving agent of the present invention. Further, the matters stated in the soil improving agent of the present invention can be appropriately applied to the method for producing a soil improving agent of the present invention.

In the method for producing a soil improving agent of the present invention, the lignin content of the lignocellulosic biomass before the hydrophilization treatment (hereinafter sometimes also referred to as the raw material lignocellulosic biomass) is preferably more than 60 mass % and 80 mass % or less.

Further, the raw material lignocellulosic biomass may have a water contact angle of 110° or less.

The hydrophilization treatment is preferably an alkali treatment, a hot water treatment, an acid treatment or a combination thereof, more preferably an alkali treatment, a hot water treatment or a combination thereof, and further preferably a combination of an alkali treatment and a hot water treatment (hereinafter sometimes also referred to as the alkali hot water treatment). The hydrophilization treatment may include a neutralizing treatment, a drying treatment or the like as necessary.

The hydrophilization treatment is preferably carried out in a medium including water.

The lignocellulosic biomass of the present invention having a contact angle with water of, for example, 95° or less, further less than 70°, further 60° or less, further 55° or less and further 50° or less is preferably obtained by the hydrophilization treatment.

Further, the lignin content of the lignocellulosic biomass after the hydrophilization treatment is preferably more than 60 mass, and 80 mass % or less.

The alkali treatment is explained.

The alkali treatment is carried out by bringing the raw material lignocellulosic biomass into contact with an alkaline medium at a predetermined temperature for a predetermined time. The alkaline medium preferably includes water. Specific examples thereof include an aqueous sodium hydroxide solution, an aqueous potassium hydroxide solution, an aqueous lithium hydroxide solution, an aqueous calcium hydroxide solution, an aqueous magnesium hydroxide solution, an aqueous sodium carbonate solution, an aqueous potassium carbonate solution, ammonia water and an aqueous tetramethylammonium hydroxide solution. The pH of the alkaline medium is preferably 10 or more and 14 or less. The temperature of the alkaline medium is preferably 10° C. or more and 50° C. or less. The contact time of the alkaline medium is preferably 0.05 hours or more and 7 days or less.

An example of the alkali treatment is the following method.

100 parts by mass of the raw material lignocellulosic biomass is mixed with 100 parts by mass or more and 2,000 parts by mass or less of an alkaline medium of an arbitrary concentration, preferably an alkaline medium selected from an aqueous sodium hydroxide solution, an aqueous potassium hydroxide solution, an aqueous lithium hydroxide solution, an aqueous calcium hydroxide solution, an aqueous magnesium hydroxide solution, an aqueous sodium carbonate solution, an aqueous potassium carbonate solution, ammonia water and an aqueous tetramethylammonium hydroxide solution to obtain a slurry. The slurry is left to stand or left alone under stirring at 10° C. or more and 50° C. or less, for example, at a room temperature, for 0.05 hours or more and 7 days or less, thus carrying out the alkali treatment.

After the alkali treatment, neutralization is preferably carried out. In the neutralization, a neutralizer, for example, hydrochloric acid or sulfuric acid of an arbitrary concentration is added to the slurry including the lignocellulosic biomass to make the pH thereof after the treatment near neutral, for example, 5.5 or more and further 6.0 or more, and 8.0 or less and further 7.0 or less. After the alkali treatment and preferably after the neutralization, drying can also be carried out.

The hot water treatment is explained.

The hot water treatment is carried out by bringing the raw material lignocellulosic biomass into contact with hot water for a predetermined time. The temperature of the hot water is preferably 80° C. or more and 200° C. or less. The contact time of the hot water is preferably 0.05 hours or more and 36 hours or less.

An example of the hot water treatment is the following method.

100 parts by mass of the raw material lignocellulosic biomass is mixed with 200 parts by mass or more and 2,000 parts by mass or less of hot water, for example, heated ion exchange water, to obtain a slurry. For example, the treatment temperature can be selected from 80° C. or more and 200° C. or less, and the treatment time can be selected from 0.05 hours or more and 36 hours or less. Under such conditions, the slurry is left to stand or left alone under stirring, thus carrying out the hot water treatment. After the hot water treatment, drying can also be carried out.

The acid treatment is explained.

The acid treatment is carried out by bringing the raw material lignocellulosic biomass into contact with an acidic medium at a predetermined temperature for a predetermined time. The acidic medium preferably includes water. Specific examples thereof include aqueous solutions of hydrochloric acid, sulfuric acid, nitric acid, phosphoric acid, acetic acid, peracetic acid, sulfurous acid, nitrous acid, oxalic acid, carbonic acid, boric acid, hypochlorous acid and the like. The pH of the acidic medium is preferably 1 or more and 5 or less. The temperature of the acidic medium is preferably 25° C. or more and 200° C. or less. The contact time of the acidic medium is preferably 0.05 hours or more and 7 days or less.

An example of the acid treatment is the following method.

100 parts by mass of the raw material lignocellulosic biomass is mixed with 200 parts by mass or more and 2,000 parts by mass or less of an acidic medium of an arbitrary concentration, preferably an acidic medium including an acid selected from hydrochloric acid, sulfuric acid, nitric acid, phosphoric acid, acetic acid, peracetic acid, sulfurous acid, nitrous acid, oxalic acid, carbonic acid, boric acid and hypochlorous acid and water to obtain a slurry. For example, the treatment temperature can be selected from 80° C. or more and 200° C. or less, and the treatment time can be selected from 0.05 hours or more and 36 hours or less. Under such conditions, the slurry is left to stand or left alone under stirring, thus carrying out the acid treatment.

After the acid treatment, neutralization is preferably carried out. In the neutralization, a neutralizer, for example, an aqueous sodium hydroxide solution of an arbitrary concentration is added to the slurry including the lignocellulosic biomass to make the pH thereof after the treatment near neutral, for example, 5.5 or more and further 6.0 or more, and 8.0 or less and further 7.0 or less. After the acid treatment and preferably after the neutralization, drying can also be carried out.

The alkali hot water treatment is explained.

The alkali hot water treatment is the alkali treatment carried out in a high-temperature alkaline medium including water. Specific examples of the alkaline medium are the same as those in the alkali treatment. The pH of the alkaline medium used in the alkali hot water treatment is preferably 9.0 or more and more preferably 10.0 or more, and preferably 14.0 or less and more preferably 13.5 or less. The temperature of the alkaline medium used in the alkali hot water treatment is preferably 10° C. or more and more preferably 50° C. or more, and preferably 180° C. or less and more preferably 150° C. or less. The contact time of the alkaline medium used in the alkali hot water treatment is preferably 0.05 hours or more and more preferably 0.5 hours or more, and preferably 36 hours or less and more preferably 24 hours or less.

An example of the alkali hot water treatment is the following method.

100 parts by mass of the raw material lignocellulosic biomass is mixed with 100 parts by mass or more and 2,000 parts by mass or less of an alkaline medium of an arbitrary concentration, preferably an alkaline medium selected from an aqueous sodium hydroxide solution, an aqueous potassium hydroxide solution, an aqueous lithium hydroxide solution, an aqueous calcium hydroxide solution, an aqueous magnesium hydroxide solution, an aqueous sodium carbonate solution, an aqueous potassium carbonate solution, ammonia water and an aqueous tetramethylammonium hydroxide solution to obtain a slurry. For example, the treatment temperature can be selected from 10° C. or more and 180° C. or less, and the treatment time can be selected from 0.05 hours or more and 36 hours or less. Under such conditions, the slurry is left to stand or left alone under stirring, thus carrying out the alkali hot water treatment.

After the alkali hot water treatment, neutralization is preferably carried out in the same manner as in the alkali treatment. After the alkali hot water treatment and preferably after the neutralization, drying can also be carried out.

When a hydrophilization treatment is carried out in a medium including water in the present invention, a treated product is preferably dried after the hydrophilization treatment and preferably after neutralization. The drying can be carried out, for example, at 50° C. or more and 200° C. or less. Specifically, the drying can be carried out by a vacuum dryer at a predetermined temperature, for example, at 50° C. until a moisture content of 10 parts by mass or less is reached.

The obtained lignocellulosic biomass with a lignin content of more than 60 mass % and 80 mass % or less as-is or processed into appropriate shape and size can be used as the soil improving agent of the present invention.

Note that the lignocellulosic biomass subjected to a hydrophilization treatment may have a water contact angle of, for example, 95° or less, further less than 70°, further 60° or less, further 55° or less and further 50° or less, and 0° or more, further 5° or more, further 10° or more and further 15° or more.

An example of the producing method of the present invention is described.

The raw material lignocellulosic biomass and water are placed in a treatment vessel, and the solids content is made to be preferably 5 mass % or more and 50 mass % or less. The raw material lignocellulosic biomass may be ground in advance to have an average particle size of preferably 0.1 μm or more and 10 mm or less. An aqueous alkali solution containing an alkali agent such as sodium hydroxide or the like is preferably used as the water. The pH of the mixture preferably falls within the aforementioned range. The contents are treated at preferably 25° C. or more and 150° C. or less for preferably 0.1 hours or more and 24 hours or less to obtain a liquid-form mixture including the lignocellulosic biomass of the present invention. An autoclave can be used for the treatment. As necessary, the mixture is made to have a pH of near neutral, preferably a pH of 5.5 or more and 8.0 or less with an acid agent, and thereafter dried at preferably 40° C. or more and 120° C. or less to obtain the lignocellulosic biomass of the present invention in solid form, or the soil improving agent of the present invention. Note that components (B) and (C) can be optionally mixed with the obtained lignocellulosic biomass to obtain the soil improving agent of the present invention.

### <Method for Improving Soil>

The method for improving soil of the present invention is a method for improving soil including, mixing the lignocellulosic biomass with a lignin content of more than 60 mass % and 80 mass % or less of component (A) with the soil. The matters stated in the soil improving agent of the present invention can be appropriately applied to the method for improving soil of the present invention. Specific examples, preferable aspects or the like for component (A) are also the same. The method for improving soil of the present invention can be carried out using the soil improving agent of the present invention.

A targeted soil of the present invention is preferably the soil of arable land to grow plants or crops.

A targeted soil of the present invention is preferably the soil of an agricultural field.

In the present invention, examples of a method for adding component (A) to the soil can include mixing component (A) or the soil improving agent of the present invention with the soil, spraying component (A) or the soil improving agent of the present invention to the soil, a combination thereof, or the like.

Specific examples of a method for adding component (A) or the soil improving agent of the present invention to the soil in an agricultural field include a method of plowing the soil while spraying thereto component (A) or the soil improving agent of the present invention using a tiller or the like together with a sprayer.

In the present invention, component (A) is added in an amount of preferably 0.0001 parts by mass or more, more preferably 0.005 parts by mass or more and further preferably 0.01 parts by mass or more, and preferably 10 parts by mass or less, more preferably 5 parts by mass or less, further preferably 2.5 parts by mass or less, furthermore preferably 2.0 parts by mass or less, furthermore preferably 1.0 parts by mass or less and furthermore preferably 0.5 parts by mass or less per 100 parts by mass of the soil, which is soil to cultivate plants. In other words, in the present invention, plants are cultivated in soil to cultivate plants containing component (A) in an amount of preferably 0.0001 parts by mass or more, more preferably 0.01 parts by mass or more and further preferably 0.05 parts by mass or more, and preferably 10 parts by mass or less, more preferably 5 parts by mass or less, further preferably 2.5 parts by mass or less, furthermore preferably 2.0 parts by mass or less, furthermore preferably 1.0 parts by mass or less and furthermore preferably 0.5 parts by mass or less per 100 parts by mass of the soil. When the soil improving agent of the present invention is used, it is preferably used such that the amount thereof as component (A) falls within this range.

When component (A) is added, for example, by spraying, to the soil in the method for improving soil of the present invention, component (A) is added in an amount of preferably 0.2 kg or more, more preferably 10 kg or more and further preferably 20 kg or more, and preferably 20,000 kg or less, more preferably 10,000 kg or less, further preferably 5,000 kg or less, furthermore preferably 4,000 kg or less, furthermore preferably 2,000 kg or less and furthermore preferably 1,000 kg or less per 10 ares (1000 m²) of the soil. When the soil improving agent of the present invention is used, it is preferably used such that the amount thereof as component (A) falls within this range.

The method for improving soil of the present invention can be applied to, for example, soil during a period of conversion of a paddy field into a field, soil after use as a field, or the soil of non-arable land. Further, the method for improving soil of the present invention can be applied to, for example, broken-up soil such as soil after tilling, and can be applied to the soil of non-arable land which is made to be arable.

The present invention further discloses the following soil improving agent, method for producing a soil improving agent and method for improving soil in connection with the above embodiments. The matters stated in the soil improving agent, the method for producing a soil improving agent and the method for improving soil of the present invention can be appropriately applied to these aspects, and vice versa.

<1>

A soil improving agent containing (A) a lignocellulosic biomass with a lignin content of more than 60 mass % and 80 mass % or less [hereinafter referred to as component (A)].

<2>

The soil improving agent according to <1>, wherein the lignin content of component (A) is more than 60 mass % and preferably 63 mass % or more, and 80 mass % or less, preferably 77 mass, or less, more preferably 75 mass % or less and further preferably 70 mass % or less.

<3>

The soil improving agent according to <1> or <2>, wherein component (A) has a contact angle with water of 110° or less, further 100° or less, further 950 or less, further less than 70°, further 600 or less, further 55° or less and further 50° or less, and 0° or more, further 5° or more, further 10° or more and further 15° or more.

<4>

The soil improving agent according to any of <1> to <3>, wherein component (A) is a plant biomass, preferably one or more selected from herbaceous biomass and woody biomass, and more preferably a herbaceous biomass.

<5>

The soil improving agent according to <4>, wherein the herbaceous biomass is one or more selected from plants of the Poaceae, Malvaceae and Fabaceae families and non-woody parts of plants of the Arecaceae family.

<6>

The soil improving agent according to <5>, wherein the plants of the Poaceae family are one or more selected from sugarcane, Sorghum, switchgrass, elephant grass, corn stover, corncobs, rice straw, wheat straw, barley, Miscanthus sinensis, sod, Johnson grass, Saccharum and Napier grass, the plants of the Malvaceae family are one or more selected from kenaf and cotton, the plant of the Fabaceae family is alfalfa, and the non-woody parts of plants of the Arecaceae family are one or more selected from palm kernel shells and palm empty fruit bunches.

<7>

The soil improving agent according to any of <1> to <4>, wherein component (A) is one or more plant seed husks selected from peach seed husks, prune seed husks, Japanese apricot seed husks, plum seed husks, peanut seed husks, walnut seed husks and palm kernel shells.

<8>

The soil improving agent according to <4>, wherein the woody biomass is one or more types of woody biomass selected from conifers and broad-leaved trees, and the woody biomass may be used by processing into woodchips or wood pulp.

<9>

The soil improving agent according to any of <1> to <4>, wherein component (A) is a biomass derived from a plant of the Arecaceae family, and further one or more types of biomass selected from palm kernel shells and coconut coir dust.

<10>

The soil improving agent according to any of <4> to <9>, wherein component (A) is obtained by subjecting the plant biomass to one or more hydrophilization treatments selected from a hot water treatment, an alkali treatment and an acid treatment.

<11>

The soil improving agent according to any of <1> to <10>, wherein component (A) is in solid form.

<12>

The soil improving agent according to any of <1> to <11>, wherein component (A) has an average particle size of preferably 1,000 μm or less, more preferably 500 μm or less, further preferably 300 μm or less, furthermore preferably 150 μm or less and furthermore preferably 100 μm or less, and preferably 0.1 μm or more, more preferably 1.0 μm or more and further preferably 10 μm or more.

<13>

The soil improving agent according to any of <1> to <12>, wherein the soil improving agent has a water contact angle with water of 110° or less, further 100° or less, further 95° or less, further less than 70°, further 60° or less, further 55° or less and further 50° or less, and 0° or more, further 5° or more, further 10° or more and further 15° or more.

<14>

The soil improving agent according to any of <1> to <13>, wherein the soil improving agent is in solid form.

<15>

The soil improving agent according to any of <1> to <14>, wherein the soil improving agent has an average particle size of preferably 1,000 μm or less, more preferably 500 μm or less, further preferably 300 μm or less, furthermore preferably 150 μm or less and furthermore preferably 100 μm or less, and preferably 0.1 μm or more, more preferably 1.0 μm or more and further preferably 10 μm or more.

<16>

The soil improving agent according to any of <1> to <15>, containing component (A) in an amount of preferably 10 mass % or more and more preferably 20 mass % or more, and preferably 100 mass % or less.

<17>

The soil improving agent according to any of <1> to <16>, containing (B) a cellulose derivative [hereinafter referred to as component (B)].

<18>

The soil improving agent according to <17>, wherein component (B) is a water-soluble cellulose.

<19>

The soil improving agent according to <17> or <18>, wherein component (B) is a cellulose ether.

<20>

The soil improving agent according to any of <17> to <19>, wherein component (B) is one or more selected from (B1) carboxymethyl cellulose or salts thereof.

<21>

The soil improving agent according to <19> or <20>, wherein component (B) has an average degree of substitution of 0.5 or more and 1.5 or less.

<22>

The soil improving agent according to any of <17> to <21>, wherein the 1 mass % aqueous solution of component (B) has a viscosity of 5 mPa·s or more, and 20,000 mPa·s or less and further 15,000 mPa·s or less at 20° C.

<23>

The soil improving agent according to any of <17> to <22>, containing component (B) in an amount of preferably 0.01 parts by mass or more, more preferably 0.1 parts by mass or more and further preferably 1 part by mass or more, and preferably 10,000 parts by mass or less, more preferably 1,000 parts by mass or less and further preferably 100 parts by mass or less relative to 100 parts by mass of component (A).

<24>

The soil improving agent according to any of <1> to <23>, containing (C) a hydroxy acid or a salt thereof [hereinafter referred to as component (C)].

<25>

The soil improving agent according to <24>, wherein component (C) is a polycarboxylic acid having a hydroxy group or a salt thereof, preferably citric acid, malic acid or a salt thereof, and more preferably citric acid or a salt thereof.

<26>

The soil improving agent according to <25>, wherein the polycarboxylic acid having a hydroxy group has 3 or more and 10 or less carbons.

<27>

The soil improving agent according to any of <24> to <26>, containing component (C) in an amount of preferably 0.01 parts by mass or more, more preferably 0.1 parts by mass or more, further preferably 1 part by mass or more and further preferably 5 parts by mass or more, and preferably 10,000 parts by mass or less, more preferably 1,000 parts by mass or less and further preferably 100 parts by mass or less relative to 100 parts by mass of component (A).

<28>

A method for producing a soil improving agent containing (A) a lignocellulosic biomass with a lignin content of more than 60 mass % and 80 mass % or less, wherein the method includes a step of subjecting the lignocellulosic biomass to a hydrophilization treatment.

<29>

The method for producing a soil improving agent according to <28>, wherein the hydrophilization treatment is an alkali treatment, a hot water treatment, an acid treatment or a combination thereof.

<30>

The method for producing a soil improving agent according to <29>, wherein the pH of an alkaline medium used in the alkali treatment is preferably 10 or more and 14 or less, the temperature of the alkaline medium is preferably 10° C. or more and 50° C. or less, and the contact time of the alkaline medium with the lignocellulosic biomass is preferably 0.05 hours or more and 7 days or less.

<31>

The method for producing a soil improving agent according to <29> or <30>, wherein the temperature of hot water used in the hot water treatment is preferably 80° C. or more and 200° C. or less, and the contact time of the hot water with the lignocellulosic biomass is preferably 0.05 hours or more and 36 hours or less.

<32>

The method for producing a soil improving agent according to any of <29> to <31>, wherein the pH of an acidic medium used in the acid treatment is preferably 1 or more and 5 or less, the temperature of the acidic medium is preferably 25° C. or more and 200° C. or less, and the contact time of the acidic medium with the lignocellulosic biomass is preferably 0.05 hours or more and 7 days or less.

<33>

The method for producing a soil improving agent according to any of <29> to <32>, wherein the hydrophilization treatment is an alkali hot water treatment, and the pH of an alkaline medium used in the alkali hot water treatment is preferably 9.0 or more and more preferably 10.0 or more, and preferably 14.0 or less and more preferably 13.5 or less, the temperature of the alkaline medium is preferably 10° C. or more and more preferably 50° C. or more, and preferably 180° C. or less and more preferably 150° C. or less, and the contact time of the alkaline medium with the lignocellulosic biomass is preferably 0.05 hours or more and more preferably 0.5 hours or more, and preferably 36 hours or less and more preferably 24 hours or less.

<34>

A method for improving soil including, mixing (A) a lignocellulosic biomass with a lignin content of more than 60 mass % and 80 mass % or less [hereinafter referred to as component (A)] with the soil.

<35>

The method for improving soil according to <34>, wherein a targeted soil is the soil of arable land to grow plants or crops.

<36>

The method for improving soil according to <34>, wherein a targeted soil is the soil of an agricultural field.

<37>

The method for improving soil according to any of <34> to <36>, wherein component (A) is mixed with the soil by mixing the soil improving agent according to any of <1> to <27> with the soil.

<38>

The method for improving soil according to any of <34> to <37>, wherein component (A) is mixed with the soil by spraying component (A) or the soil improving agent according to any of <1> to <27> to the soil.

<39>

The method for improving soil according to any of <34> to <38>, wherein the soil is plowed while component (A) or the soil improving agent according to any of <1> to <27> is sprayed to the soil.

<40>

The method for improving soil according to any of <34> to <39>, wherein component (A) is added in an amount of preferably 0.0001 parts by mass or more, more preferably 0.005 parts by mass or more and further preferably 0.01 parts by mass or more, and preferably 10 parts by mass or less, more preferably 5 parts by mass or less, further preferably 2.5 parts by mass or less, furthermore preferably 2.0 parts by mass or less, furthermore preferably 1.0 parts by mass or less and furthermore preferably 0.5 parts by mass or less per 100 parts by mass of the soil, which is soil to cultivate plants.

<41>

The method for improving soil according to any of <34> to <40>, wherein component (A) is added in an amount of preferably 0.2 kg or more, more preferably 10 kg or more and further preferably 20 kg or more, and preferably 20,000 kg or less, more preferably 10,000 kg or less, further preferably 5,000 kg or less, furthermore preferably 4,000 kg or less, furthermore preferably 2,000 kg or less and furthermore preferably 1,000 kg or less per 10 ares of the soil.

<42>

The method for improving soil according to any of <34> to <41>, wherein the soil is soil during a period of conversion of a paddy field into a field.

<43>

The method for improving soil according to any of <34> to <41>, wherein the soil is soil after use as a field.

<44>

The method for improving soil according to any of <34> to <41>, wherein the soil is the soil of non-arable land.

<45>

The method for improving soil according to any of <34> to <44>, wherein the soil is broken-up soil after tilling.

### EXAMPLES

### Production Example 1

Palm kernel shells (PKS) (palm kernel shells, JAPAN PULP AND PAPER COMPANY LIMITED), a raw material biomass, was ground with the batch-type vibration mill “MB-1” (manufactured by CHUO KAKOHKI CO., LTD., total capacity of the vessel 3.5 L, SUS 304 rod circular in cross-sectional shape with φ30 and a length of 218 mm as a medium, the number of rods 13) under the conditions of a frequency of 20 Hz and a total amplitude of 8 mm for 5 minutes to obtain a soil improving agent of inventive product 1 in powder form. Inventive product 1 had an average particle size of 63.7 μm.

### Production Example 2

Palm kernel shells (PKS) (palm kernel shells, JAPAN PULP AND PAPER COMPANY LIMITED, the same product as in production example 1), a raw material biomass, was roughly ground with a roll crusher under the condition of a gap between the grinding rolls of 2 mm. The obtained roughly-ground PKS in a dry mass of 200 g was placed in a glass beaker, and a 0.1 mass aqueous sodium hydroxide solution was added thereto to make the solids content 20 mass %. While stirred with a stirring rod, the mixture was heated at 80° C. for 2 hours in a water bath to obtain a reaction product. The obtained slurry was subjected to vacuum filtration with a polyethylene filter cloth (manufactured by Sankyo Kanaami Seisakujo co., ltd., 40 mesh), and then, the obtained solid was subjected to vacuum drying at 80° C. Thereafter, 100 g of the dried product was ground with the batch-type vibration mill “MB-1” (manufactured by CHUO KAKOHKI CO., LTD., total capacity of the vessel 3.5 L, SUS 304 rod circular in cross-sectional shape with φ30 and a length of 218 mm as a medium, the number of rods 13) under the conditions of a frequency of 20 Hz and a total amplitude of 8 mm for 5 minutes to obtain a soil improving agent of inventive product 2 in powder form. In this example, the addition amounts of the 0.1 mass % aqueous sodium hydroxide solution and NaOH relative to 100 parts by mass of PKS, the raw material biomass, were 400 parts by mass and 0.4 parts by mass, respectively. Further, inventive product 2 had an average particle size of 65.05 μm.

Note that the addition amounts shown in the treatment conditions in Table 1 are those relative to 100 parts by mass of PKS.

### <Method for Measuring Contact Angle>

0.2 g of a soil improving agent in a dry state was pressurized with a powder molding machine (Minilabo press MP-50, manufactured by Labonect co., ltd.) until 20 MPa was reached to form a pellet (diameter 10 mm). The instantaneous contact angle of the obtained pellet when 5 μL of ion exchange water was added dropwise thereto was photographed at a magnification of ×25 using a digital microscope (VHX-1000, manufactured by KEYENCE CORPORATION). The contact angle was determined by a half-angle method from the taken images. Note that measurements were made three times and the average value was determined.

Table 1 shows treatment conditions, the lignin content of component (A) or the like for soil improving agents of inventive products and a comparative product used in the examples and comparative examples described later. The lignin content of component (A) was determined by the Klason lignin method. In other words, the percentage of an acid-insoluble lignin and the percentage of an acid-soluble lignin were summed to calculate the total lignin content in accordance with the TAPPI official analysis method T222om-83.

Calcium lignosulfonate (Lignosuper D, manufactured by KONO NEW MATERIAL DEVELOPMENT CO., LTD.) was used as-is as comparative product 1.

TABLE 1
Soil improving agent

| | Component (A) | | | | | | | | | | | |
|---|---|---|---|---|---|---|---|---|---|---|---|---|
| | | Treatment conditions | | | | | | | | | | |
| | | Addition | Addition | | | | | | | | | |
| | | amount of | amount of | | | | | Component (B) | | Component (C) | | Water |
| | Raw material | aqueous NaOH | NaOH | Temper- | | Lignin | Parts | | Parts | | Parts | contact |
| | biomass | solution | (parts by | ature | Treatment | content | by | | by | | by | angle |
| Designation | Type | (parts by mass) | mass) | (° C.) | time | (mass %) | mass | Type | mass | Type | mass | (°) |
| Comparative | Calcium | — | — | — | — | 82.9 | 100 | — | — | — | — | 34.0 |
| product 1 | lignosulfonate | | | | | | | | | | | |
| | (not treated) | | | | | | | | | | | |
| Inventive | PKS | — | — | — | — | 65.0 | 100 | — | — | — | — | 45.5 |
| product 1 | (not treated) | | | | | | | | | | | |
| Inventive | PKS | 400 | 0.4 | 80 | 2.0 | 65.0 | 100 | — | — | — | — | 34.2 |
| product 2 | | | | | | | | | | | | |

| | | | | | | | |
|---|---|---|---|---|---|---|---|
| Inventive | Inventive product 2 | 100 | CMC(1) | 10.0 | — | — | 45.2 |
| product 3 | | | | | | | |
| Inventive | Inventive product 2 | 100 | CMC(2) | 10.0 | — | — | 44.4 |
| product 4 | | | | | | | |
| Inventive | Inventive product 2 | 100 | CMC(2) | 40.0 | — | — | 49.6 |
| product 5 | | | | | | | |
| Inventive | Inventive product 2 | 100 | CMC(2) | 10.0 | Sodium | 40.0 | 24.6 |
| product 6 | | | | | citrate | | |
| Inventive | Inventive product 2 | 100 | HEC | 40.0 | — | — | 41.5 |
| product 7 | | | | | | | |
| Inventive | Inventive product 2 | 100 | C-HEC | 40.0 | — | — | 46.2 |
| product 8 | | | | | | | |
| Inventive | Inventive product 2 | 100 | HPMC | 40.0 | — | — | 60.2 |
| product 9 | | | | | | | |
| Inventive | Inventive product 2 | 100 | CMC(2) | 10.0 | Citic | 40.0 | 24.1 |
| product 10 | | | | | acid | | |
| Inventive | Inventive product 2 | 100 | CMC(2) | 10.0 | Sodium | 40.0 | 36.6 |
| product 11 | | | | | malate | | |

Components in the table are listed below.

CMC (1): sodium carboxymethyl cellulose, manufactured by Daicel Corporation, CMC 2260 (degree of etherification: 0.8 to 1.0, viscosity of 1 mass % aqueous solution at 20° C.: 4000 to 6000 mPa·s)

CMC (2): sodium carboxymethyl cellulose, manufactured by Daicel Corporation, CMC 1390 (degree of etherification: 1.0 to 1.5, viscosity of 1 mass % aqueous solution at 20° C.: 2500 to 4500 mPa·s)

HEC: hydroxyethyl cellulose, manufactured by Daicel Miraizu Ltd., HEC DAICEL SP900 (viscosity of 1 mass % aqueous solution at 25° C. (catalog value): 4000 to 5500 mPa·s)

C-HEC: hydroxyethylcellulose hydroxypropyl trimethylammonium chloride ether, manufactured by Kao Corporation, POIZ C-150L (molecular weight: 1,500,000)

HPMC: hydroxypropyl methylcellulose, manufactured by Shin-Etsu Chemical Co., Ltd., METOLOSE 65SH-4000 (viscosity of 2 mass % aqueous solution at 20° C. (catalog value): 4000 mPa·s)

Sodium citrate: trisodium citrate, manufactured by FUJIFILM Wako Pure Chemical Corporation

Citric acid: manufactured by FUJIFILM Wako Pure Chemical Corporation

Sodium malate: disodium DL-malate n-hydrate, manufactured by FUJIFILM Wako Pure Chemical Corporation

### Example 1 and Comparative Example 1

300 g of Arakida soil (particle size 2 to 8 mm), 60 g of water, and then, a soil improving agent selected from Table 1 in an amount of 0.1 parts by mass relative to 100 parts by mass of the soil were placed in Tupperware and stirred for 2 minutes, and thereafter dried at 80° C. for 30 minutes, and then, the contact angle of the surface of a soil aggregate was measured. For the contact angle, a soil aggregate with a particle size of 5 mm was selected, and the instantaneous contact angle of the surface of the soil aggregate when 5 μL of water was added dropwise thereto was photographed at a magnification of ×25 using a digital microscope (VHX-1000, manufactured by KEYENCE CORPORATION). The contact angle was determined by a half-angle method from the taken images. Note that measurements were made five times and the average value was calculated. The results are shown in Table 2. This evaluation is an indicator of prevention of reaggregation of soil, and the larger the contact angle is, the higher the hydrophobicity is. High soil hydrophobicity is considered to be desirable from the viewpoint of the ability to crush soil in tilling operations with a tiller.

TABLE 2

| | | Soil improving agent | | | Contact |
|---|---|---|---|---|---|
| | | | | Addition | angle of |
| | | | Lignin | amount | surface |
| | | | content | (parts | of soil |
| | | Designation | (mass %) | by mass) | aggregate (°) |
| Comparative | 1-1 | None | — | — | 26.4 |
| example | 1-2 | Comparative | 82.9 | 0.1 | 27.6 |
| | | product 1 | | | |
| Example | 1-1 | Inventive | 64.0 | 0.1 | 33.8 |
| | | product 2 | | | |

### Example 2 and Comparative Example 2

A soil improving agent selected from Table 1 was uniformly scattered over soil in a region of 5 m×1.5 m in an addition amount shown in Table 3 (kg per 10 ares of the soil), and the soil was tilled by a large tiller (manufactured by ISEKI & CO., LTD., NTA-253, speed: 0.3 km/h, the number of revolutions of tiller: 250 rpm, the number of tilling times: 1 time). After that, a total of 900 cc of the soil in the region was sampled from any three places at a depth of 0 to 5 cm, brought together and dried at 80° C. for 24 hours, and thereafter measured using 2-mm, 8-mm and 16-mm mold sieves, and mass measurement was made according to particle sizes, i.e., 2 mm or less, more than 2 mm and 8 mm or less, more than 8 mm and 16 mm or less, and more than 16 mm, and the respective percentages were thereafter calculated to obtain a particle size distribution. The results are shown in Table 3. This evaluation is an indicator of the ability to crush soil (ease of crushing), and the fewer soil clods with a particle size of more than 16 mm is, the more excellent the soil crushing performance is.

TABLE 3

| | | Soil improving agent | | | Particle size distribution (mass %) | | | |
|---|---|---|---|---|---|---|---|---|
| | | | Lignin | Addition | | More than | More than | |
| | | | content | amount | 2 mm or | 2 mm and | 8 mm and | More than |
| | | Designation | (mass %) | (kg/10 are) | less | 8 mm or less | 16 mm or less | 16 mm |
| Comparative | 2-1 | None | — | — | 4.3 | 15.3 | 27.3 | 53.1 |
| example | | | | | | | | |
| Example | 2-1 | Inventive | 64.0 | 100 | 8.5 | 27.5 | 36.9 | 27.1 |
| | | product 2 | | | | | | |

### Example 3 and Comparative Example 3

50 g of soil, 11.5 g of water and a soil improving agent selected from Table 1 in an addition amount shown in Table 4 (parts by mass relative to 100 parts by mass of the soil) were added to a SUS pan (diameter 20 cm, height 7 cm), and thereafter stirred with a stirrer (manufactured by AS ONE CORPORATION., PAN TYPE GRANULATOR PZ-01R) at 30 rpm for 5 minutes and at 50 rpm for 2 minutes. After stirring, images were taken, and a particle size distribution was calculated by the image analysis software ImageJ (developed by the National Institutes of Health). This evaluation is an indicator of soil aggregation, and the fewer particles with a particle size of 2 mm or less is and the greater particles with a particle size of more than 2 mm is, the more adequate the obtained soil aggregates are.

TABLE 4

| | | Soil improving agent | | | | | |
|---|---|---|---|---|---|---|---|
| | | | | Addition | Particle size distribution (mass %) | | |
| | | | Lignin | amount | | More than | |
| | | | content | (parts by | 2 mm or | 2 mm and | More than |
| | | Designation | (mass %) | mass) | less | 4 mm or less | 4 mm |
| Comparative | 3-1 | None | — | — | 52.8 | 46.5 | 0.7 |
| Example | | | | | | | |
| | 3-2 | Comparative | 82.9 | 0.1 | 44.0 | 54.6 | 1.4 |
| | | product 1 | | | | | |
| Example | 3-1 | Inventive | 64.0 | 0.1 | 13.6 | 85.2 | 1.2 |
| | | product 2 | | | | | |

### Example 4 and Comparative Example 4

To a 100-cc cup in which 20 g of soil was placed, a soil improving agent in Table 1 was further added in an addition amount shown in Table 5 (parts by mass relative to 100 parts by mass of the soil), and 2.5 g of water was thereafter added, and the mixture was stirred with a spatula to form soil aggregates. Soil aggregates with a particle size of about 3 to 5 mm were selected and one of them was placed in a dish with a diameter of 35 mm, and the dish was shaken 30 times by hand to shape the soil aggregate into a sphere. The shaped soil aggregate was gently placed in water at a room temperature, and then, while it was left to stand, the time until it collapsed was measured to evaluate the water resistance. Measurements were made in eight repetitions, and the average value was calculated. Note that the maximum measurement time was 600 seconds, and if no collapse occurred after 600 seconds, the indication of “more than 600” was made in the table. This evaluation is an indicator of the water resistance of a soil aggregate, and the longer the time is, the more excellent the water resistance is.

TABLE 5

| | | Soil improving agent | | |
|---|---|---|---|---|
| | | | Addition amount | Water resistance |
| | | Designation | (parts by mass) | (second) |
| Comparative | 4-1 | None | — | 197 |
| example | 4-2 | Comparative | 0.1 | 195 |
| | | product 1 | | |
| Example | 4-1 | Inventive | 0.1 | 251 |
| | | product 1 | | |
| | 4-2 | Inventive | 0.1 | 281 |
| | | product 2 | | |
| | 4-3 | Inventive | 0.1 | 320 |
| | | product 3 | | |
| | 4-4 | Inventive | 0.1 | 328 |
| | | product 4 | | |
| | 4-5 | Inventive | 0.1 | More than 600 |
| | | product 5 | | |
| | 4-6 | Inventive | 0.1 | 402 |
| | | product 6 | | |
| | 4-7 | Inventive | 0.1 | 313 |
| | | product 7 | | |
| | 4-8 | Inventive | 0.1 | 387 |
| | | product 8 | | |
| | 4-9 | Inventive | 0.1 | 295 |
| | | product 9 | | |
| | 4-10 | Inventive | 0.1 | 403 |
| | | product 10 | | |
| | 4-11 | Inventive | 0.1 | 365 |
| | | product 11 | | |

Note that, as in the case of inventive product 2, a larger contact angle of the surface of a soil aggregate (example 1) and more preferable particle size distributions (examples 2 and 3) were obtained in the case where inventive products 1 to 11 were used compared to the case where no soil improving agents or comparative product 1 was used. Thus, inventive products 1 to 11 are soil improving agents that advantageously work on the ability to crush soil and soil aggregation.

1: A soil improving agent, comprising:
(A) a lignocellulosic biomass with a lignin content of more than 60 mass % and 80 mass % or less,
wherein the component (A) has an average particle size of 1.000 μm or less.

2: The soil improving agent according to claim 1, wherein the component (A) is a biomass derived from a plant of the Arecaceae family.

3. (canceled)

4: The soil improving agent according to claim 1, further comprising:
(B) a cellulose derivative.

5: The soil improving agent according to claim 4, wherein the component (B) is a cellulose ether.

6: The soil improving agent according to claim 4, comprising the component (B) in an amount of 0.01 parts by mass or more and 10,000 parts by mass or less relative to 100 parts by mass of the component (A).

7: The soil improving agent according to claim 1, further comprising:
(C) a hydroxy acid or a salt thereof.

8: The soil improving agent according to claim 7, comprising the component (C) in an amount of 0.01 parts by mass or more and 10,000 parts by mass or less relative to 100 parts by mass of the component (A).

9: A method for producing a soil improving agent comprising (A) a lignocellulosic biomass with a lignin content of more than 60 mass % and 80 mass % or less, the method comprising:
subjecting the lignocellulosic biomass to a hydrophilization treatment.

10: A method for improving soil, the method comprising:
mixing (A) a lignocellulosic biomass with an average particle size of 1,000 μm or less and a lignin content of more than 60 mass % and 80 mass % or less with the soil.

11: The method for improving soil according to claim 10, wherein the soil is soil of an agricultural field.

12: The soil improving agent according to claim 1, wherein the soil improving agent has a water contact angle with water of less than 70° and 15° or more.

13: The soil improving agent according to claim 1, wherein the component (A) is a hydrophilized lignocellulosic biomass.

14: The soil improving agent according to claim 4, wherein the component (B) is one or more selected from the following (B1) to (B6):
(B1) carboxyalkyl celluloses or salts thereof,
(B2) carboxyalkyl alkyl celluloses or salts thereof;
(B3) alkyl celluloses;
(B4) hydroxyalkyl celluloses;
(B5) alkyl hydroxyalkyl celluloses; and
(B6) cationized celluloses.

15: The soil improving agent according to claim 7, wherein the component (C) is citric acid, malic acid or salts of these.

16: The method for producing a soil improving agent according to claim 9, wherein the hydrophilization treatment is an alkali hot water treatment.

17: The method for improving soil according to claim 10, wherein the component (A) is a hydrophilized lignocellulosic biomass.

18: The method for improving soil according to claim 10, wherein a soil improving agent comprising the component (A) and (B) a cellulose derivative is mixed with the soil.

19: The method for improving soil according to claim 10, wherein a soil improving agent comprising the component (A) and (C) a hydroxy acid or a salt thereof is mixed with the soil.

20: The method for improving soil according to claim 10, wherein a soil improving agent comprising the component (A), (B) a cellulose derivative, and (C) a hydroxy acid or a salt thereof is mixed with the soil.
